(19) United States
(12) Patent Application Publication
(10) Pub. No.: US 2020/0216643 A1
(43) Pub. Date: Jul. 9, 2020

(54) RUBBER COMPOSITION FOR ANTI-VIBRATION RUBBERS, AND ANTI-VIBRATION RUBBER FOR VEHICLES

(71) Applicant: BRIDGESTONE CORPORATION, Tokyo (JP)

(72) Inventor: Chihiro UCHIDE, Chuo-ku, Tokyo (JP)

(73) Assignee: BRIDGESTONE CORPORATION, Tokyo (JP)

(21) Appl. No.: 16/634,912

(22) PCT Filed: Jul. 5, 2018
(86) PCT No.: PCT/JP2018/025599

§ 371 Date: Jan. 29, 2020

(30) Foreign Application Priority Data
Aug. 2, 2017 (JP) 2017-150123

(51) Int. Cl. C08L 9/00; C08L 7/00; F16F 1/36

(52) U.S. Cl. CPC C08L 9/00; C08L 7/00; F16F 2224/025; C08L 2205/035; C08L 2205/025; F16F 1/3605

(57) ABSTRACT

An object of the present disclosure is to provide a rubber composition for anti-vibration rubbers which is excellent in high hysteresis loss properties and an anti-vibration rubber for vehicles which is excellent in vibration damping performance. Specifically, a rubber composition for anti-vibration rubbers comprises: a rubber component containing a diene-based rubber; 40 to 120 parts by mass of carbon black with respect to 100 parts by mass of the rubber component; and 20 to 80 parts by mass of a resin with respect to 100 parts by mass of the rubber component, wherein the resin contains 10 parts by mass or more of a xylene resin with respect to 100 parts by mass of the rubber component.

### TECHNICAL FIELD

The present invention relates to a rubber composition for anti-vibration rubbers, and an anti-vibration rubber for vehicles.

### BACKGROUND ART

An anti-vibration rubber is provided at a site generating vibrations and noises in a vehicle of various types such as automobile vehicle in order to improve riding comfort thereof. In order to reduce propagation of vibrations and noises into the interior of a vehicle, an anti-vibration rubber is employed, for example, for structural members such as a torsional damper, an engine mount, a muffler hanger and the like of an engine as a primary source of vibrations and noises in an automobile vehicle so that the anti-vibration rubber adsorbs vibrations generated when the engine is driven and thus well prevents vibrations and noises from being propagated into the interior of the automobile vehicle and the noise from being diffused into the surrounding environment.

Such an anti-vibration rubber as described above is required to have, as the basic characteristics thereof, high strength for supporting a heavy member such as an engine and good damping properties for satisfactorily absorbing and suppressing vibrations of the heavy member. A variety of techniques has been developed for this purpose.

Specifically, increasing hysteresis loss (tan δ) of an anti-vibration rubber has been demanded in terms of improving vibration damping performance of the anti-vibration rubber. As far as resonant vibrations (“shakes”) generated at low frequencies are concerned, the larger hysteresis loss (hysteresis loss will occasionally be referred to simply as “loss” hereinafter) results in the lower transmissibility of vibrations.

For example, PTL 1 discloses, as a technique for realizing high loss properties of an anti-vibration rubber, a technique of using a specific high loss polymer as a rubber component so as to improve the hysteresis loss properties of the anti-vibration rubber.

### CITATION LIST

### Patent Literature

PTL 1: JP 09-176387 Laid-Open

### SUMMARY

As described above, the technique of PTL 1 made it possible to realize a certain level of high loss properties of an anti-vibration rubber. However, considering the recent increasingly strict requirements for reducing noises and vibrations, an anti-vibration rubber having yet higher hysteresis loss needs to be developed in terms of further improving vibration damping performance thereof.

In view of this, an object of the present disclosure is to provide a rubber composition for anti-vibration rubbers which is excellent in high hysteresis loss properties thereof and an anti-vibration rubber for vehicles which is excellent in vibration damping performance thereof.

The inventors of the present disclosure discovered, as a result of a keen study to achieve the aforementioned object, that it is possible to realize a rubber composition for anti-vibration rubbers having very high hysteresis loss that has never been achieved by the conventional rubber composition for anti-vibration rubbers, by composing a rubber component of the rubber composition mainly out of diene-based rubber and including carbon black and a specific type of resin by a specific content in the rubber composition.

Specifically, a rubber composition for anti-vibration rubbers of the present disclosure has: a rubber component containing a diene-based rubber; 40 to 120 parts by mass of carbon black with respect to 100 parts by mass of the rubber component; and 20 to 80 parts by mass of a resin with respect to 100 parts by mass of the rubber component, wherein the resin contains 10 parts by mass or more of a xylene resin with respect to 100 parts by mass of the rubber component.

Excellently high hysteresis loss of the rubber composition can be achieved by the aforementioned compositional characteristics.

In the rubber composition for anti-vibration rubbers of the present disclosure, it is preferable that the carbon black has a nitrogen adsorption specific surface area (N₂SA) of ≥30 m²/g. The high hysteresis loss properties of the rubber composition can be further improved in this case.

In the rubber composition for anti-vibration rubbers of the present disclosure, it is preferable that a content of the carbon black is in the range of 60 to 120 parts by mass with respect to 100 parts by mass of the rubber component. The high hysteresis loss properties of the rubber composition can be further improved in this case.

In the rubber composition for anti-vibration rubbers of the present disclosure, it is preferable that the carbon black is ISAF or SAF. The high hysteresis loss properties of the rubber composition can be further improved in this case.

In the rubber composition for anti-vibration rubbers of the present disclosure, it is preferable that the resin includes 20 parts by mass or more of a xylene resin with respect to 100 parts by mass of the rubber component. The high hysteresis loss properties of the rubber composition can be further improved in this case.

In the rubber composition for anti-vibration rubbers of the present disclosure, it is preferable that a content of the resin is in the range of 40 to 80 parts by mass with respect to 100 parts by mass of the rubber component. The high hysteresis loss properties of the rubber composition can be further improved in this case.

An anti-vibration rubber for vehicles of the present disclosure is characterized in that it uses a crosslinked rubber composition for anti-vibration rubbers, obtained by subjecting the rubber composition for anti-vibration rubbers of the present disclosure to crosslinking.

Excellent vibration damping performance can be realized by the aforementioned structural feature.

According to the present disclosure, it is possible to provide i) a rubber composition for anti-vibration rubbers which is excellent in high hysteresis loss properties thereof and ii) an anti-vibration rubber for vehicles which exhibits excellent vibration damping performance without sacrificing good controllability and stability of a vehicle in which the anti-vibration rubber is mounted.

### DETAILED DESCRIPTION

<Rubber Composition for Anti-Vibration Rubbers>

Hereinafter, an embodiment of a rubber composition for anti-vibration rubbers of the present disclosure will be described in detail.
The rubber composition for anti-vibration rubbers of the present disclosure contains: a rubber component including a diene-based rubber therein; 40 to 120 parts by mass of carbon black with respect to 100 parts by mass of the rubber component; and 20 to 80 parts by mass of a resin with respect to 100 parts by mass of the rubber component, wherein the resin characteristically includes therein 10 parts by mass of a xylene resin with respect to 100 parts by mass of the rubber component.

The rubber composition for anti-vibration rubbers of the present disclosure has realized high hysteresis loss that the conventional anti-vibration rubbers failed to achieve, by i) composing a rubber component thereof primarily out of diene-based rubber, ii) including high-grade carbon black in the rubber composition, and iii) including a resin by a larger content than usual in the rubber composition, which resin contains a xylene resin therein by a certain content or more 10 parts by mass with respect to 100 parts by mass of the rubber component).

The majority of the conventional rubber compositions for anti-vibration rubbers, in contrast, attempted to achieve high hysteresis loss by adjusting types of rubber components and carbon blacks thereof.

(Rubber Component)

The rubber component, contained in the rubber composition for anti-vibration rubbers of the present disclosure, includes a diene-based rubber therein.
The rubber component may either be 100% composed of the diene-based rubber(s) or include a rubber other than a diene-based rubber unless the inclusion thereof adversely affects the object of the present disclosure.
A content of the diene-based rubber in the rubber component is preferably 50 mass %, more preferably ≥80 mass %, and most preferably 100 mass %.

Type of the diene-based rubber is not particularly restricted and may be appropriately selected in accordance with the performances required of the rubber composition for anti-vibration rubbers. Specific examples of the diene-based rubber include natural rubber (NR), isoprene rubber (IR), styrene-butadiene rubber (SBR), styrene-isoprene-butadiene rubber (SIBR), ethylene-propylene-diene rubber (EPDM), chloroprene rubber (CR), acrylonitrile-butadiene rubber (NBR), butyl rubber (IIR), butadiene rubber (BR), and the like. “BR” represents polybutadiene as a polymer of 1,3-butadiene and it does not include a copolymer or the like of butadiene and other polymers in the present disclosure.

It is preferable that the diene-based rubber includes at least one selected from the group consisting of natural rubber, isoprene rubber, butadiene rubber and styrene-butadiene rubber among the specific examples described above. It is more preferable in this regard that butadiene rubber is ≥50 parts by mass with respect to 100 parts by mass of the rubber component.

(Resin)

The rubber composition for anti-vibration rubbers of the present disclosure contains, in addition to the rubber component described above, a resin including therein a xylene resin.
It is possible to realize very good “high hysteresis loss” properties of the rubber composition for anti-vibration rubbers by including therein, by an appropriate content, a resin containing a xylene resin.
A “resin” represents a conventional resin, which excludes rubbers in general including the aforementioned rubber component, in the present disclosure.

A content of the resin is to be in the range of 20 to 80 parts by mass with respect to 100 parts by mass of the rubber component in terms of realizing satisfactorily good high hysteresis loss properties. When the content of the resin is less than 20 parts by mass with respect to 100 parts by mass of the rubber component, satisfactorily good high hysteresis loss properties of the rubber composition may not be obtained. When the content of the resin exceeds 80 parts by mass with respect to 100 parts by mass of the rubber component, workability in manufacturing the rubber composition may deteriorate. The content of the resin is preferably in the range of 40 to 80 parts by mass with respect to 100 parts by mass of the rubber component in terms of realizing yet better high hysteresis loss properties of the rubber composition.

Regarding the resin, inclusion of a xylene resin therein suffices and type(s) of other resin(s) is not particularly restricted. Examples of a resin other than the xylene resin include phenol resin, rosin resin, dicyclopentadiene (DCPD) resin, dicyclopentadiene-isoprene copolymer, CS-based petroleum resin, C9-based petroleum resin, alicyclic petroleum resin, petroleum resin obtained by copolymerizing a C5 fraction and a C9 fraction (C5-C9-based petroleum resin), terpene resin, ketone resin, modified resins of the aforementioned resins, and the like. These examples of the resin may be used by either a single type or two or more types in combination.

A content of the xylene resin in the resin is to be 10 parts by mass with respect to 100 parts by mass of the rubber component. When the content of the xylene resin in the resin is less than 10 parts by mass with respect to 100 parts by mass of the rubber component, satisfactorily good high hysteresis loss properties of the rubber composition may not be obtained. The content of the xylene resin in the resin is preferably ≥20 parts by mass with respect to 100 parts by mass of the rubber component in terms of realizing yet better high hysteresis loss properties of the rubber composition.

(Carbon Black)

The rubber composition for anti-vibration rubbers of the present disclosure contains carbon black in addition to the rubber component and the resin described above. It is possible to maintain physical properties such as strength of the rubber composition for anti-vibration rubbers in a satisfactory manner by including carbon black, by an appropriate content, in the rubber composition.

A content of the carbon black is to be in the range of 40 to 120 parts by mass and preferably in the range of 60 to 120 parts by mass with respect to 100 parts by mass of the rubber component. It is possible to realize in this case good high hysteresis loss properties of the rubber composition, while maintaining other physical properties such as strength of the rubber composition in a satisfactory manner, even when hysteresis loss of the rubber composition is increased by addition of the resin as described above. The content of carbon black, which is less than 40 parts by mass with respect to 100 parts by mass of the rubber component, may not realize satisfactorily high strength and satisfactorily good high hysteresis loss properties of the rubber composition. The content of carbon black, which exceeds 120 parts by mass with respect to 100 parts by mass of the rubber component, may increase viscosity of rubber in an unvulcanized state too much and deteriorate workability in manufacturing the rubber composition.

The carbon black preferably has a nitrogen adsorption specific surface area (N₂SA) of ≥30 m²/g. It is possible to realize in this case yet better high hysteresis loss properties of the rubber composition than otherwise, while maintaining other physical properties such as strength of the rubber composition in a satisfactory manner, even when hysteresis loss of the rubber composition is increased by addition of the resin as described above. From the same point of view, N₂SA of the carbon black is more preferably ≥40 m²/g, further more preferably ≥70 m²/g, and particularly preferably 100 m²/g. The upper limit of N₂SA of the carbon black is not particularly restricted but N₂SA of the carbon black is preferably ≤130 m²/g in terms of avoiding deterioration of other physical properties of the rubber composition.

N₂SA of the carbon black can be measured by the single-point measuring procedures according to ISO 4652-1. For example, a specific surface area (m²/g) of carbon black can be determined by: immersing a degassed carbon black sample into liquid nitrogen; measuring an amount of nitrogen adsorbed at surfaces of the carbon black sample in an equilibrium state; and calculating a specific surface area (m²/g) of the carbon black sample from the amount of adsorbed nitrogen (and the weight of the sample) thus measured.

The carbon black preferably has a grade higher than FEF, so that it is possible to realize yet better high hysteresis loss properties of the rubber composition than otherwise, while maintaining other physical properties such as strength of the rubber composition in a satisfactory manner, even when hysteresis loss of the rubber composition is increased by addition of the resin as described above. The grade of the carbon black, which is preferably higher than FEF as described above, is more preferably ISAF or SAF, so that strength and the high hysteresis loss properties of the rubber composition can be further improved.

(Other Components)

The rubber composition for anti-vibration rubbers of the present disclosure may contain, in addition to the rubber component, the resin and the carbon black described above, additives such as a filler other than carbon black, a crosslinking agent, a crosslinking accelerator, a crosslinking accelerator auxiliary, an anti-aging agent, an antioxidant, a foaming agent, a plasticizer, a lubricant, a tackifier, an ultraviolet absorbing agent, and the like unless addition thereof adversely affects the object of the present disclosure. Contents of the other components described above are not particularly restricted.

Type of the filler is not particularly restricted and fillers such as silica, white carbon, particulate magnesium silicate, heavy calcium carbonate, magnesium carbonate, clay, talc, and the like can be appropriately used.

Type of the crosslinking agent is not particularly restricted and examples thereof include sulfur.

Inclusion of a crosslinking agent by an appropriate content in the rubber composition for anti-vibration rubbers allows a crosslinking reaction to occur in the rubber composition. A content of the crosslinking agent is preferably in the range of 0.4 to 5 parts by mass and more preferably in the range of 0.6 to 3 parts by mass with respect to 100 parts by mass of the rubber component.

Type of the crosslinking accelerator is not particularly restricted and the conventionally known crosslinking accelerator can be used. Examples of the crosslinking accelerator include: thiazole-based vulcanization accelerator such as 2-mercaptobenzothiazole, dibenzothiazyl disulfide; sulfenamide-based vulcanization accelerator such as N-cyclohexyl-2-benzothiazyl sulfenamide, N-t-butyl-2-benzothiazyl sulfenamide; guanidine-based vulcanization accelerator such as diphenylguanidine; thiuram-based vulcanization accelerator such as tetramethylthiuram disulfide, tetraethylthiuram disulfide, tetrabutylthiuram disulfide, tetradodecylthiuram disulfide, tetraoctylthiuram disulfide, tetrabenzylthiuram disulfide, dipentamethylenethiuram tetrasulfide; dithiocarbamate salt-based vulcanization accelerator such as zinc dimethyldithiocarbamate; zinc dialkyldithiophosphate; and the like.

Either a single type or two or more types in combination selected from the sulfenamide-based vulcanization accelerator, the thiuram-based vulcanization accelerator, the thiazole-based vulcanization accelerator, the guanidine-based vulcanization accelerator and the dithiocarbamate salt-based vulcanization accelerator can be used as the crosslinking accelerator. Combining the thiuram-based vulcanization accelerator and/or the thiazole-based vulcanization accelerator, which exhibits relatively high crosslinking acceleration ability, with the guanidine-based vulcanization accelerator and/or the sulfenamide-based vulcanization accelerator, which exhibits moderate or relatively low crosslinking acceleration ability, is suitable as an application in terms of adjusting the crosslinking behavior (rate). Specific examples of the combination include a combination of tetramethylthiuram disulfide and N-cyclohexyl-2-benzothiazyl sulfenamide, a combination of tetrabutylthiuram disulfide and N-t-butyl-2-benzothiazyl sulfenamide, a combination of dibenzothiazyl disulfide and diphenylguanidine, and the like.

Examples of the crosslinking accelerator auxiliary include zinc white (ZnO), fatty acid, and the like. The fatty acid may be any of saturated, unsaturated, normal, and branched fatty acids. The number of carbon atoms of the fatty acid, which is not particularly restricted, either, may be in the range of 1 to 30, preferably in the range of 15 to 30. Specific examples of the fatty acid include: naphthenic acid such as cyclohexanoic acid (cyclohexanecarboxylic acid), alkylcyclopentane having a side chain; saturated fatty acid such as hexanoic acid, octanoic acid, decanoic aid (including a branched carboxylic acid such as neodecanoic acid), dodecanoic acid, tetradecanoic acid, hexadecanoic acid, octadecanoic acid (stearic acid); unsaturated fatty acid such as methacrylic acid, oleic acid, linoleic acid, linolenic acid; resin acid such as rosin, tall-oil acid, abietic acid; and the like. These examples of the crosslinking accelerator auxiliary may be used by either a single type or two or more types in combination. Zinc white and stearic acid can be preferably used in the present disclosure.

Type of the antioxidant/the anti-aging agent is not particularly restricted and those conventionally known can be used. Examples of the antioxidant include: a phenol-based antioxidant, an imidazole-based antioxidant, an amine-based antioxidant, and the like. These examples of the antioxidant may be used by either a single type or two or more types in combination.

A method for blending the respective components described above in obtaining the rubber composition for anti-vibration rubbers of the present disclosure is not particularly restricted. Either raw materials of all components may be mixed and kneaded together at a time or the respective components may be blended, i.e. mixed and kneaded, in stages, for example, over two or three stages. Conventionally known mixing and kneading devices such as rolls, an internal mixer, a Banbury rotor or the like can be used in the mixing and kneading process. In a case where the rubber composition is to be formed into a sheet-like or a belt-like configuration, conventionally known molding devices such as an extrusion molding machine, a press machine or the like can be used.

<Anti-Vibration Rubber for Vehicles>

An anti-vibration rubber for vehicles of the present disclosure is characterized in that it uses a crosslinked rubber composition for anti-vibration rubbers, which is obtained by subjecting the aforementioned rubber composition for anti-vibration rubbers of the present disclosure to crosslinking.
It is possible to realize excellent vibration damping performance without sacrificing good controllability and stability of a vehicle in which an anti-vibration rubber is mounted, by using for the anti-vibration rubber a crosslinked rubber composition for anti-vibration rubbers, which is obtained by subjecting the rubber composition for anti-vibration rubbers of the present disclosure to crosslinking.

With regard to hysteresis loss of the crosslinked rubber composition for anti-vibration rubbers, tan δ at 15 Hz of the crosslinked rubber composition is preferably ≥0.5 and more preferably ≥0.6 at the room temperature (23±2° C.). The vibration damping performance can be further improved in this case.

Crosslinking (vulcanization) conditions under which the rubber composition for anti-vibration rubbers is cured are not particularly restricted. For example, a vulcanization process in which vulcanization is carried out at 140 to 180° C. for 5 to 120 minutes can be employed.

In the present disclosure, an anti-vibration rubber for vehicles represents a crosslinked rubber product used for preventing/alleviating propagation of vibrations in a vehicle (an automobile/a passenger car, a truck, a bus, trains, a construction machine like an excavator) by utilizing internal friction of the product. Specifically, an anti-vibration rubber for vehicles represents a product used in such a vehicle as described above for the aforementioned purpose in a state where the crosslinked rubber composition for anti-vibration rubbers is in contact/integral with a rigid body made of resin, metal or the like. Examples of a method for making the crosslinked rubber composition for anti-vibration rubbers integral with a rigid body include a non-adhesion type method such as injecting the rubber into a rigid body, a method of attaching the rubber to a rigid body by way of an adhesive, and the like. It is acceptable in this regard to use as the rubber a fluid-sealed-in type anti-vibration rubber in which a fluid is sealed to obtain a vibration propagation preventing effect by the fluid, as well.

The anti-vibration rubber for vehicles of the present disclosure is preferably an anti-vibration rubber for automobiles and more preferably an anti-vibration rubber used for a chassis component, an engine mount member, and the like in an automobile. It is possible to realize excellent vibration damping performance, by the satisfactory high hysteresis loss properties obtained by the crosslinked rubber composition for anti-vibration rubbers, in this case.

### EXAMPLES

The present disclosure will be described further in detail by Examples hereinafter. The present disclosure is not limited by any means by these Examples.

### Examples 1 to 12, Comparative Examples 1 to 2

Respective samples of a rubber composition for anti-vibration rubbers are/were prepared according to the component compositions/formulations shown in Table 1.

Then, respective samples of a crosslinked rubber composition for anti-vibration rubbers are/were prepared by subjecting the respective samples of the rubber composition for anti-vibration rubbers thus prepared to a vulcanization treatment involving heating at 155° C. for 12 to 26 minutes.

(Evaluation)

The following evaluations (1) to (3) are/were made for each of the samples of the crosslinked rubber composition for anti-vibration rubbers.

(1) Hardness (Hd)

Hardness is/was measured for each of the samples of the crosslinked rubber composition for anti-vibration rubbers according to JIS K 6253 (Type A). Measurement results are shown in Table 1.
With regard to the hardness thus measured, the larger value represents the higher hardness.

(2) Elongation at Break (Eb)

Elongation at break (%) is/was measured for each of the samples of the crosslinked (vulcanized) rubber composition for anti-vibration rubbers according to JIS K 6251 at 23° C. Measurement results are shown in Table 1.
With regard to the elongation at break thus measured, the larger value represents the larger elongation at break.

(3) Hysteresis Loss Properties (Tan δ)

Hysteresis loss or tan δ is/was measured for each of the samples of the crosslinked rubber composition for anti-vibration rubbers according to JIS K 6394: 2007 under the conditions of 15 Hz (and 100 Hz) at 23° C.±2° C. Measurement results are shown in Table 1.
With regard to the tan δ thus measured, the larger value represents the higher hysteresis loss.

TABLE 1

| | | Example 1 | Example 2 | Example 3 | Example 4 | Example 5 | Example 6 | Example 7 | Example 8 |
|---|---|---|---|---|---|---|---|---|---|
| Component | Natural rubber | — | 100 | 70 | — | — | — | — | — |
| compositions | Butyl rubber | — | — | 30 | — | — | — | — | — |
| (parts by mass | Polybutadiene rubber | 70 | — | — | 50 | 70 | 70 | 70 | 70 |
| with respect to | Styrene-butadiene rubber | — | — | — | — | — | — | — | — |
| 100 parts by mass | Isoprene rubber *⁷ | 30 | — | — | 50 | 30 | 30 | 30 | 30 |
| of rubber component) | Carbon black A *¹ | — | — | — | — | — | — | — | 100 |
| | Carbon black B *² | 100 | 100 | 100 | 100 | 120 | 40 | 70 | — |
| | Zinc white | 5 | 5 | 5 | 5 | 5 | 5 | 5 | 5 |
| | Resin A *³ | 20 | 20 | 20 | 20 | 20 | 20 | 20 | 20 |
| | Resin B *⁴ | 20 | 20 | 20 | 20 | 20 | 20 | 20 | 20 |
| | Resin C *⁵ | 30 | 30 | 30 | 30 | 30 | 30 | 30 | 30 |
| | Resin D *⁶ | — | — | — | — | — | — | — | — |
| | Sulfur | 2 | 2 | 2 | 2 | 2 | 2 | 2 | 2 |
| Evaluations | H d | 66 | 72 | 74 | 68 | 76 | 43 | 57 | 58 |
| | E b (%) | 1000 | 690 | 760 | 960 | 820 | 1050 | 1100 | 640 |
| | tanδ (15 Hz) | 0.6 | 0.7 | 0.7 | 0.6 | 0.6 | 0.5 | 0.6 | 0.5 |

| | | | | | Comp. | | Comp. |
|---|---|---|---|---|---|---|---|
| | | Example 9 | Example 10 | Example 11 | Example 1 | Example 12 | Example 2 |
| Component | Natural rubber | — | — | — | — | — | 25 |
| compositions | Butyl rubber | — | — | — | — | — | — |
| (parts by mass | Polybutadiene rubber | 70 | 70 | 70 | 70 | 70 | 70 |
| with respect to | Styrene-butadiene rubber | — | — | — | — | — | 5 |
| 100 parts by mass | Isoprene rubber *⁷ | 30 | 30 | 30 | 30 | 30 | — |
| of rubber component) | Carbon black A *¹ | — | — | — | — | — | — |
| | Carbon black B *² | 100 | 100 | 100 | 100 | 100 | 80 |
| | Zinc white | 5 | 5 | 5 | 5 | 5 | 5 |
| | Resin A *³ | 20 | 20 | 20 | — | 10 | — |
| | Resin B *⁴ | 20 | 20 | — | — | 10 | 10 |
| | Resin C *⁵ | 20 | 10 | — | 20 | 10 | 15 |
| | Resin D *⁶ | — | — | — | — | — | 10 |
| | Sulfur | 2 | 2 | 2 | 2 | 2 | 2 |
| Evaluations | H d | 69 | 73 | 78 | 77 | 80 | 71 |
| | E b (%) | 950 | 860 | 560 | 550 | 600 | 950 |
| | tanδ (15 Hz) | 0.6 | 0.6 | 0.5 | 0.4 | 0.5 | 0.4 |

*¹ FEF carbon black: “Seast SO” (N₂SA = 42 m²/g) manufactured by Tokai Carbon Co., Ltd.
*² ISAF carbon black: “Seast 6P” (N₂SA =119 m²/g) manufactured by Tokai Carbon Co., Ltd.
*³ Xylene resin: “NIKANOL ®” manufactured by Fudow Co., Ltd.
*⁴ Polyester polyol resin: “Zeofine 100M” manufactured by Zeon Corporation
*⁵ Dicyclopentadiene resin: “MARUKAREZ M-890A” manufactured by Maruzen Petrochemical Co., Ltd.
*⁶ Aromatic hydrocarbon resin: “Nisseki Neopolymer 140” manufactured by JXTG Nippon Oil & Energy Corporation
*⁷ “ASADENE ® NF35R” manufactured by Asahi Kasei Corporation

It is understood from the results shown in Table 1 that the respective samples of Examples unanimously exhibit better high hysteresis loss properties than the respective samples of Comparative Examples.

### INDUSTRIAL APPLICABILITY

According to the present disclosure, it is possible to provide a rubber composition for anti-vibration rubbers which is excellent in high hysteresis loss properties thereof and an anti-vibration rubber for vehicles which is excellent in vibration damping performance thereof.

1. A rubber composition for anti-vibration rubbers, wherein it comprises:
a rubber component containing a diene-based rubber;
40 to 120 parts by mass of carbon black with respect to 100 parts by mass of the rubber component; and
20 to 80 parts by mass of a resin with respect to 100 parts by mass of the rubber component,
wherein the resin contains 10 parts by mass or more of a xylene resin with respect to 100 parts by mass of the rubber component.

2. The rubber composition for anti-vibration rubbers of claim 1, wherein the carbon black has a nitrogen adsorption specific surface area (N₂SA) of ≥30 m²/g.

3. The rubber composition for anti-vibration rubbers of claim 1, wherein a content of the carbon black is in the range of 60 to 120 parts by mass with respect to 100 parts by mass of the rubber component.

4. The rubber composition for anti-vibration rubbers of claim 1, wherein the carbon black is ISAF or SAF.

5. The rubber composition for anti-vibration rubbers of claim 1, wherein the resin includes 20 parts by mass or more of a xylene resin with respect to 100 parts by mass of the rubber component.

6. The rubber composition for anti-vibration rubbers of claim 1, wherein a content of the resin is in the range of 40 to 80 parts by mass with respect to 100 parts by mass of the rubber component.

7. An anti-vibration rubber for vehicles, wherein it uses a crosslinked rubber composition for anti-vibration rubbers, obtained by subjecting the rubber composition for anti-vibration rubbers of claim 1 to crosslinking.
